(19) United States
(12) Patent Application Publication
(10) Pub. No.: US 2017/0300823 A1
(43) Pub. Date: Oct. 19, 2017

(54) DETERMINING USER INFLUENCE BY CONTEXTUAL RELATIONSHIP OF ISOLATED AND NON-ISOLATED CONTENT

(71) Applicant: International Business Machines Corporation, Armonk, NY (US)

(72) Inventors: James E. Bostick, Cedar Park, TX (US); John M. Ganci, JR., Cary, NC (US); Martin G. Keen, Cary, NC (US); Sarbajit K. Rakshit, Kolkata (IN); Craig M. Trim, Sylmar, CA (US)

(21) Appl. No.: 15/097,454

(22) Filed: Apr. 13, 2016

(51) Int. Cl. G06N 7/00; H04L 29/08

(52) U.S. Cl. CPC G06N 7/005; H04L 67/306

(57) ABSTRACT

One or more processor to receives content over distributed network media sources and isolated content, authored by one or more users of the plurality of users, in which the content and isolated content are directed to a plurality of topics. The content and isolated content are parsed into content segments and aggregated based on topics to which the content segments are directed, and users authoring the content segments are identified, the aggregated content segments forming at least part of a discussion thread. One or more processors determine a probability that the discussion thread is complete, based on a set of user behavioral pattern metrics generated by analysis of historical content, and one or more processors, in response to the discussion thread being substantially complete and exceeding a probability threshold, determines the discussion thread, including the content and the isolated content to be ready for a contextual relationship analysis.

### FIELD OF THE INVENTION

The present invention relates generally to the field of social media contextual relationships, and more particularly to predicting influence between users having contextual relationships.

### BACKGROUND OF THE INVENTION

Users of social media often participate in discussions or conversations within a common media exchange platform, such as a chat room, forum, messaging exchange, email, and phone conversations. The media content may include a collection of posts and replies in which users participate in discussions of particular topics with particular users. Media-based discussions seldom include an overt indicator of the end or completeness of the discussion, and in some instances a discussion may include multiple topics, some that may overlap within the same timeframe.

The opportunity for discussion of topics offered by social media providers includes several types of communication on various platforms. Users may have discussion or conversation interactions on audio channels (i.e., voice-over-IP, phone call), text messaging services, on-line community forums, blogs, tweets, comments, likes, and email. Discussion of topics that extend across different communication types and platforms by multiple users, may not be easily recognized, and casual determination of the content of a discussion thread may be incomplete.

### SUMMARY

Embodiments of the present invention disclose a method, computer program product, and system. The method provides for one or more processor to gather content authored by a plurality of users over distributed network media sources, and isolated content authored by one or more users of the plurality of users, in which the content and isolated content are directed to a plurality of topics. One or more processors gather content authored by a plurality of users over distributed network media sources, and isolated content authored by one or more users of the plurality of users, wherein the content and isolated content are directed to a plurality of topics. One or more processors parse the content and the isolated content. One or more processors aggregate the content that is parsed and the isolated content that is parsed, which are directed to a topic of the plurality of topics, such that the parsed content and parsed isolated content, which are aggregated, form at least a portion of a discussion thread. One or more processors identify a set of users of the plurality of users, authoring the content that is parsed and the isolated content that is parsed, which are directed to the topic. One or more processors determine a probability of whether the discussion thread is at least substantially complete, based on a set of metrics of behavioral patterns of the plurality of users, identified by analysis of historical content and isolated historical content authored by the plurality of users, and in response to determining the probability of the discussion thread to exceed a probability threshold indicating the discussion thread to be at least substantially complete, one or more processors perform a contextual relationship analysis between instances of the parsed content and instances of the parsed isolated content that are directed to the topic, which are authored by the set of users of the plurality of users.

### BRIEF DESCRIPTION OF THE SEVERAL VIEWS OF THE DRAWINGS

FIG. 1 is a functional block diagram illustrating a distributed network processing environment, in accordance with an embodiment of the present invention.

FIG. 2 illustrates an example of isolated media content of a discussion thread by multiple users, in accordance with an embodiment of the present invention.

FIG. 3A is a block diagram illustrating content segments of isolated media content, in accordance with an embodiment of the present invention.

FIG. 3B is a block diagram illustrating the contextual relationship analysis of the content segments of isolated media content of FIG. 3A, in accordance with an embodiment of the present invention.

FIG. 4 illustrates a graphical sequence diagram of a discussion thread content between multiple users, in accordance with an embodiment of the present invention.

FIG. 5A illustrates operational steps of a thread analysis program, within the distributed network processing environment of FIG. 1, in accordance with an embodiment of the present invention.

FIG. 5B illustrates operational steps of a thread analysis program, within the distributed network processing environment of FIG. 1, in accordance with an embodiment of the present invention.

FIG. 6 depicts a block diagram of components of a system, including a server capable of operationally performing the thread analysis program, in accordance with an embodiment of the present invention.

### DETAILED DESCRIPTION

Embodiments of the present invention recognize that interactions between users participating in social network communication can result in one user providing influence over one or more other users. Understanding the relationship of users in the context of the topic and the thread of discussion by analyzing the content from each user can be used to establish a predictive model of influence, preference, behavior, and even attitude of users. In embodiments of the present invention, user-generated content from distributed network media sources is analyzed to establish contextual relationships among the users and generated content for various communication threads. Historical content generated by a plurality of users is analyzed to determine the behavioral attributes and patterns of each user with regard to participation, addition, response, timing and frequency associated with contributions to a communication discussion thread. In some embodiments, the contextual relationships of communication discussion threads are tracked and analyzed to determine the influence of one or more users over other users participating in the discussion threads. In some embodiments of the present invention, social network communication content that is generated by a particular set of users is used to determine the contextual relationships of available isolated media content of the particular set of users. The isolated content is analyzed to complete the content contributions of discussion threads, and to determine the contextual relationship among all content segments, the users that generated the social network and isolated content segments, and the topics associated with discussion threads of the combined isolated content and social network communication content.

In some embodiments of the present invention, a determination is made as to the probability that a particular communication thread among a set of users is complete or nearly complete. Expressed alternatively, embodiments of the present invention predict the probability that a user of a particular set of users engaged in a discussion thread of an online communication will reply or add content to the discussion thread towards the objective of determining whether a particular discussion thread is complete. Determining whether a discussion thread is complete insures that valuable content, which is pertinent to determining influence or relationships between users for a topic, is included in the analysis performed. If the analysis is performed prior to the discussion thread reaching completion, or near completion, valuable content may be missed, and results may lack accuracy. A communication thread is analyzed by a thread analysis program utilizing cognitive components, natural language processing, and machine learning techniques to determine the content segments or elements, of the communication content that are contextually related, identifying the users generating the content, and topics associated with a discussion thread of the contextually related elements of the communication topic.

In some embodiments of the present invention, psycholinguistic analysis techniques are applied to the social network content and isolated communication content generated by a particular user to determine personality traits associated with the particular user. The psycholinguistic analysis is used as a contributing factor to determine a probability of a user replying to or adding to an existing discussion thread of communication content.

In some embodiments of the present invention, a probabilistic model is created based on a discussion sequence diagram that includes publicly posted (or otherwise available) communication on distributed network media sources, and isolated communication content types, to predict the impact on user mood, opinion, and decision making. The analysis of contextually related communication content that is probabilistically determined to be complete or nearly complete is used to identify an effect of influence by one or more users on other users. Determining user influence is based on identifying a particular user that is undecided regarding a topic within an earlier point in a discussion thread that includes the one or more influential users, and then later in the discussion thread determining the particular user to be decisive (or more decisive) regarding the topic of the discussion thread.

In some embodiments of the present invention, content of variable type is received or gathered from different platforms of communication content across distributed network media sources, and isolated content sources. For example, communication content types may include, text messages, audio messages, posted images, and posted video clips (that may include audio). Communication platforms may include sources of short messaging service (SMS) text, email, postings on forums, blogs, as well as online chat and discussion sites and applications. Content may also be included from accessible isolated sources, such as personal log files, electronic diaries, calendars, and personal memos. Isolated content may be related to content posted on social network platforms but lack the clear connection to other content topics, users, and time sequences that may accompany social network content. Embodiments of the present invention determine the contextual relationship of isolated content to corresponding social network content, determining more complete discussion threads for a topic, enabling a more effective predictive model of determining a user's influence on other users.

Contextual relationship, as discussed herein, refers to the relationship between content gathered from various content platforms, and the social media data sets of content types and platform sources. Analysis of contextual relationship of content includes determination of topic consistency, clustering of content segments associated with a topic, identification of users that generate the related content, determination of discussion threads, including isolated content, and the relationship of users within a discussion thread for a given topic. The analysis includes determining the probability of one thread of a first data set being related to another thread of a second data set, and determination of whether a discussion thread is complete or nearly complete.

Embodiments of the present invention transform historical discussion content into a probabilistic determination that a current discussion thread is substantially complete for a set of contributing users, and embodiments transform current discussion thread content into a determination of user influence over other users, for a particular topic.

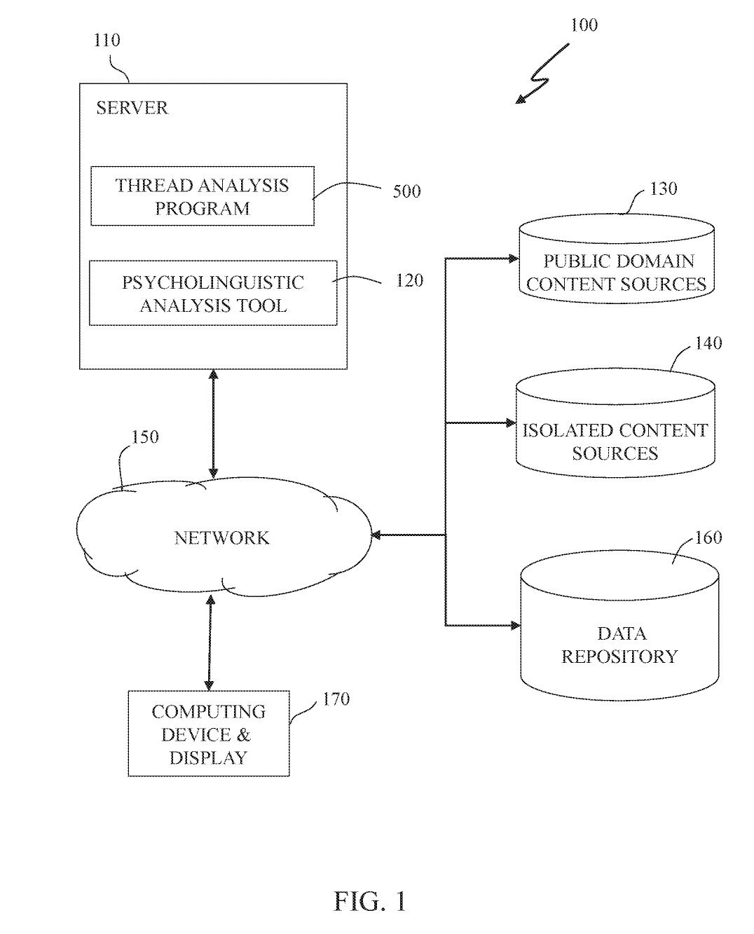

The present invention will now be described in detail with reference to the Figures. FIG. 1 is a functional block diagram illustrating a distributed network processing environment, generally designated 100, in accordance with an embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed network processing environment 100 includes computing device and display 170, data repository 160, isolated content sources 140, public domain content sources 130, and server 110, which is shown to include thread analysis program 500 and psycholinguistic analysis tool 120, all inter-connected via network 150.

Network 150 can be, for example, a local area network (LAN), a telecommunications network, a wide area network (WAN), such as the Internet, a virtual local area network (VLAN), or any combination that can include wired, wireless, or optical connections. Network 150 can include one or more wired and/or wireless networks that are capable of receiving and transmitting data, text, voice, and/or video signals, including multimedia signals that include text, voice, data, and video information. In general, network 150 can be any combination of connections and protocols that will support communications between computing device and display 170, big data repository 160, isolated content sources 140, public domain content sources 130, and server 110.

Computing device and display 170 receives and displays output from thread analysis program 500. In some embodiments of the present invention, the output from thread analysis program 500 includes identification of a particular topic of a discussion thread, the users associated with the discussion thread, and the determined probability of the completion of the discussion thread content, is displayed. In some embodiments, the displayed information includes the relationship of the users associated with the discussion thread, with respect to the content submitted by each user, and the time frame sequence of the submitted content. The displayed relationship information may be listed or may represented in a graphical time sequence diagram and include information regarding the influence, by one or more users, on other users of the discussion thread. In other embodiments, the relationship information may be displayed alternatively on a display device connected to server 110.

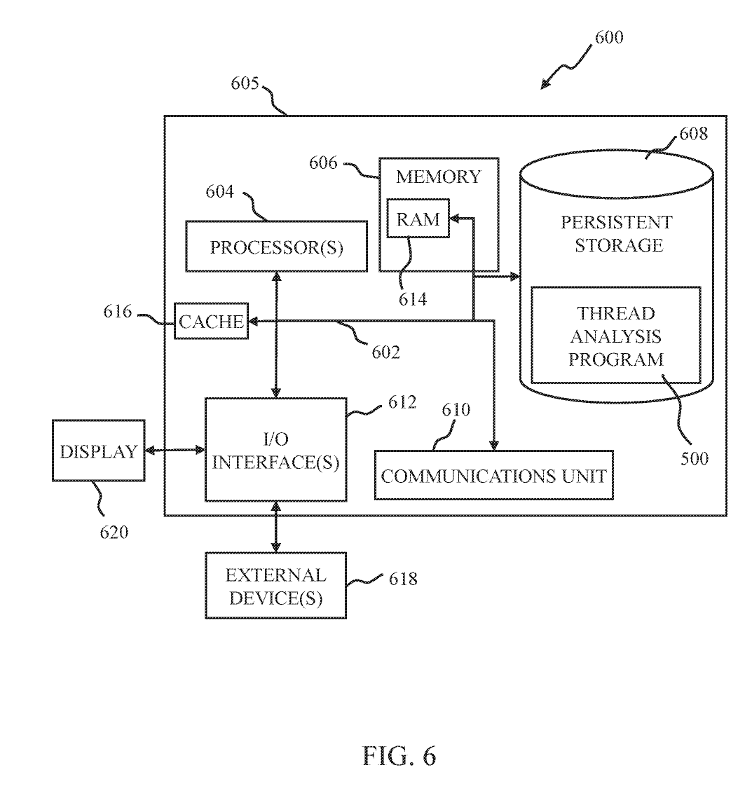

In some embodiments, computing device and display 170 may represent a virtual computing device of a computing system utilizing multiple computers as a server system, such as in a cloud computing environment. In another embodiment, computing device and display 170 may be a laptop computer, a tablet computer, a netbook computer, a personal computer (PC), a desktop computer, a personal digital assistant (PDA), a smart phone, or any programmable electronic device capable of receiving data from other devices and applications of distributed network processing environment, via network 150. In another embodiment, computing device and display 170 represents a computing system utilizing clustered computers and components (e.g., database server computers, application server computers, etc.) that act as a single pool of seamless resources when accessed within distributed network processing environment 100. Computing device and display 170 may include internal and external hardware components, as depicted and described with reference to FIG. 6.

Data repository 160 receives and stores media content generated by a plurality of users engaged in communication of various types, across various sources and platforms. Media content stored on data repository 160 includes, but is not limited to, audio conversations, text messaging, tweets, emails, posted text content on forums, chat communities, and blogs, including comments and likes. The media content stored on data repository 160 also includes historical isolated content from isolated content sources 140, generated and made accessible by users, which may include personal notes, logs, calendar entries, and diaries, for example. Isolated media content includes entries made by a particular user to a source platform made accessible by the user, whereas social network media content includes posts, responses, and comments by a plurality of users, and is generally accessible. Data repository 160 includes historical media content generated by a plurality of users, and includes current media content from discussion threads of a set of users of the plurality of users. Data repository 160 is connected to server 110 and thread analysis program 500 via network 150.

Isolated content sources 140 represents the various sources of isolated media content, which includes, but is not limited to, personal log entries, online notes or notebooks, diaries, and calendar information. In some embodiments of the present invention, email communications sent or received by a particular user are included in isolated content sources 140. Isolated content sources 140 includes communication media content generated by a particular user but not necessarily directed to other users for delivery. The relationship of content from isolated content sources 140 to other public or isolated content is usually not obvious as compared to a more publicly accessible discussion in which the media content identifies users and input generated by a user, and responses generated by a user, as well as providing a discernable time sequence of generated content. In embodiments of the present invention, the media content from isolated content sources 140 has been designated as accessible and is received and included in data repository 160. Isolated content sources 140 is connected to server 110 and thread analysis program 500 via network 150.

Public domain content sources 130 represents various sources of distributed network media sources that include public media content, which includes but is not limited to, text documents, text messaging, tweets, emails, posted text content on forums, chat communities, and blogs, including comments and likes, and audio conversations that can be transcribed by voice-to-text applications. Public domain content sources 130 are generally social media content sources, and in some embodiments, include email sent or received by a particular user. In embodiments of the present invention, the content generated by users of various types of public domain communications or social media is accessible from public domain content sources 130, includes identification of the user generating each input of a discussion thread, and is stored in data repository 160. Public domain content sources 130 is connected to server 110 and thread analysis program 500 via network 150.

Server 110 provides computing and operational support of psycholinguistic analysis tool 120, and thread analysis program 500. In some embodiments of the present invention, server 110 is a host for psycholinguistic analysis tool 120, and thread analysis program 500, as depicted in FIG. 1. In other embodiments, server 110 is remotely connected to one or both of, psycholinguistic analysis tool 120, and thread analysis program 500, which may be hosted on other devices (not shown), but are connected to server 110 via network 150.

In some embodiments of the present invention, server 110 can be a management server, a web server, a mobile computing device, or any other electronic device or computing system capable of receiving, sending, and processing data, and supporting the operational functions of thread analysis program 500. In other embodiments, server 110 can represent a server computing system utilizing multiple computers as a server system, such as in a cloud computing environment. In still other embodiments, server 110 can be a laptop computer, a tablet computer, a netbook computer, a personal computer (PC), a desktop computer, a personal digital assistant (PDA), a smart phone, or any programmable electronic device capable of performing programmable instructions of thread analysis program 500, and enabling access of data from public domain content sources 130, isolated content sources 140, and data repository 160, within distributed network processing environment 100, via network 150. In another embodiment, server 110 represents a computing system utilizing clustered computers and components (e.g., database server computers, application server computers, etc.) that act as a single pool of seamless resources when accessed within distributed network processing environment 100. Server 110 may include internal and external hardware components, as depicted and described in further detail with respect to FIG. 6.

Psycholinguistic tool 120 analyzes the media content contributed by a particular user of the plurality of users generating the media content of public domain content sources 120 and isolated content sources 140, which is stored in data repository 160. Psycholinguistic tool 120 analyzes the content generated by a particular user and determines a psychological profile of the particular user, based on the generated content. The psychological profile of the particular user includes intrinsic traits, such as personality, values, and needs, and accomplishes this by correlating traits, word choices, and activity patterns included in multiple instances of the media content input by the particular user. The analysis brings together expertise in text analytics, human-computer interaction, psychology, and large-scale data processing. One approach gathers data and correlates the choice of words and phrases in tweets from people who have taken personality tests. This establishes a correlation of personality traits to social media word choices, and the word choice correlation can be applied to people who have not taken the personality tests, enabling personality trait determination by a person's social media word choices.

Thread analysis program 500 includes a set of modules that utilize machine learning and cognitive techniques in performing analysis on the historical media content stored in data repository 160, and analysis on current media content of a discussion thread. The analysis of the historical content identifies the users that generate the content determines the content segments associated with each user and defines the topic of each content segment. In some embodiments of the present invention, the cognitive modules of thread analysis program 500 determine the content-generating behavior patterns and traits of users based on the analysis of the historical communication content among sets of users. The analysis further determines a probability of a user replying to an existing content segment of a discussion thread, adding to a discussion thread, and initiating new discussion threads. The analysis includes consideration of the users within a particular discussion thread, the relationship between the users, the topic of the discussion thread, the number and frequency of responses by users of the discussion thread, and the duration of time between responses and additions to the discussion thread. Based on the information generated by thread analysis program 500 performing an analysis on the historical media content of a set of users participating in a current discussion thread, a probability threshold is established for determining whether the current discussion thread is complete or substantially complete (i.e., nearly complete), so as to produce meaningful results upon analysis of the current discussion threads. If a particular discussion thread among a set of users does not exceed a threshold probability that the discussion thread is complete, then thread analysis program 500 does not perform analysis on the thread at that time; waiting until the probability threshold of the discussion thread being complete is exceeded.

Thread analysis program 500 analyzes historical content discussion threads and user interactions, and determines behavioral patterns for the plurality of users generating content. Data associated with the source provenance practiced and preferred by each user for generating content is determined, such as blogs, wikis, personal diary, private logs, or popular social media applications. Similarly, other behavioral attributes of users are determined from the historical discussion thread content, such as the content types preferred by users. For example, behavioral patterns of a user, which may serve as metrics in subsequent analysis, include content types the user may prefer, such as text, audio, video, or images, and include the topics to which a user initiates or provides replies and comments, and the number and timing of interactions in a discussion thread, based on participating users and the discussion thread topic. For example, a user may respond three times on average for discussions of topic Y and have a response time distribution in which half of responses occur within four hours, an additional quarter of responses occur within eight hours, and an additional quarter of responses occur after a day.

In some embodiments of the present invention, the generated content is gathered from public domain content sources 130 and isolated content sources 140, and stored in data repository 160; available to thread analysis program 500. A particular instance of content may be determined by a particular time period, such as the content generated within the previous seven days. The particular instance of content may be defined as the content generated by a particular set of users, or may be determined by the content generated within one or more particular social network sources. The particular instance may also be determined by combinations of time period, user sets, content sources, and other factors. The analysis by a cognitive component of thread analysis program 500 on the historical content media stored in data repository 160 results in a predictive probability of users replying or adding content to current on-going discussion threads, as well as initiating new discussion threads. The results of the analysis indicate user behavioral patterns with respect to the frequency and duration of time between responses and additions to discussions, and determine relationships among users and contextual relationship of the content, with respect to topics of discussion threads.

For each user that generates content of one or more discussion threads, key metrics are identified which are used to determine a probability that the user has completed responses and additions to a discussion thread, thus determining an overall probability that the discussion thread is complete or at least substantially complete. Determining the completion of a discussion thread insures that analysis of discussion threads includes pertinent content.

The users that have generated the historical content data are determined and identified. For each of the users, a psycholinguistics profile is created using existing techniques of analyzing posted content by users to determine key personality attributes and predicted behavior. The key metrics and psycholinguistic profile for each user that generates historical discussion thread content are used in determining whether a current discussion thread is substantially or nearly complete for contextual relationship analysis. The current discussion thread is analyzed with respect to the activity of contribution of authoring and receiving users, and the probability the users will continue to comment or add to the discussion thread. The probability that the users contributing to the discussion thread will continue to comment or add to the discussion thread is based on the metrics of behavioral patterns derived from the analysis of the historical content and applying the metrics to the analysis of the discussion thread content segments. In response to a probability indicating the discussion thread is complete or at least substantially complete, thread analysis program 500 performs a contextual analysis on the current discussion thread.

In some embodiments of the present invention, thread analysis program 500 receives the results of the historical content analysis and applies the predictive probabilities of user response or additions to current discussion content, to determine discussion threads and whether discussion threads are complete or substantially complete. Thread analysis program 500 determines if one or more of the metrics used to determine whether the discussion thread is complete have exceeded a threshold probability, and if the threshold has not been exceeded, thread analysis program 500 takes no immediate action. If the threshold probability is exceeded, thread analysis program 500 determines that the discussion thread is complete or substantially complete, and performs analysis on the discussion thread, including identification and analysis of available isolated content for users identified as generating content segments of the discussion thread.

Having determined a probability of predictable behavior of the users from historical media content of a plurality of discussion threads, thread analysis program 500 receives, or obtains, current content from accessible social networks, such as public domain content sources 130, and accessible or provided current isolated content from isolated content sources 140. Thread analysis program 500 determines the contextual relationships among the content segments from current communication content, and the users that have generated the current content segments. Thread analysis program 500 identifies the contextual relationship of content segments from publicly posted content, generated by a set of users, such as content posted on popular social media sites. Additionally, thread analysis program 500 receives and analyzes the accessible isolated content of the set of users associated with the current communication content. The publicly posted content includes posted content on popular social media sites, such as Facebook®, Twitter® WhatsApp® (Facebook, Twitter, and WhatsApp are registered trademarks in the U.S. and other countries worldwide), and similar social media sites, as well as blogs, wikis, and forums. The isolated content includes content that has been made accessible from personal logs, files, diaries, calendars, memos, and other sources that don't include indicators connecting content to discussion threads and other users. In addition to being physically removed from a discussion thread of publicly posted content, the isolated content may be posted at a time that differs from the publicly posted content. Isolated content may be made accessible by default or designation in Enterprise environments and may be accessible by permission in public environments, for example.

Content associated with the current discussion thread is identified, including isolated content sources that are potentially related to the current discussion thread. The content is parsed into content segments, which may include one or more sentences, a phrase, an n-gram of words, or individual words. Content segments are analyzed to identify components, such as identifying keywords and key phrases, and in some embodiments of the present invention, semantic analysis and sentiment analysis is performed on the parsed content. In some embodiments, n-grams may be generated from parsing the content, and each n-gram of parsed content is compared with each other n-gram of parsed content to determine a probability of whether a relationship and relevancy exists between parsed content components within the current discussion thread content. Isolated content will similarly be parsed and may include semantic and sentiment analysis and be compared to other content of the discussion thread for relationship and relevancy. One or more topics of the current discussion thread, and the relationship of discussion thread content with respect to the topic and the participating users, are determined by thread analysis program 500. In some embodiments of the present invention, thread analysis program 500 represents the contextual relationship of the current discussion thread content by generating a discussion sequence diagram, comprising nodes for each participating user, and edges representing additions and comments from a participating user directed to one or more other participating users. The generated discussion sequence diagram, representing the contextual relationship of the content segments of the current discussion thread, may be displayed, for example, on computing device and display 170.

After each sentence, phrase, n-gram, or keyword is extracted and parsed from the current discussion thread and from isolated content of the users participating in the current discussion thread, which may include content from multiple sources and of multiple types, the parsed content segments may be combined or remain as parsed, and are assigned to one or more clusters, based on the relationship of each portion of parsed content to other portions of parsed content (i.e., a relationship of each content segment to one or more other content segments of the parsed content of the current discussion thread and the isolated content of the users participating in the discussion thread), such that clustered portions of parsed content share a common discussion thread topic.

Thread analysis program 500 performs an analysis of the isolated content, identifying the user that generated the content, and creating a probabilistic model of relationship between content segments of isolated content of a user to content segments of social network sources and other isolated content generated by other users.

Thread analysis program 500 clusters content segments that are determined to have a high probability to be associated with a particular topic and set of users, forming a discussion thread, based on identifying users associated with content segments, topics, keywords and key phrases, semantic and sentiment analysis, and where applicable, time sequence of posted content. Thread analysis program 500 applies the behavioral patterns determined from historical content analysis, for the set of users of the discussion thread, to determine a probability of whether the current discussion thread is complete, or at least substantially complete. The behavioral patterns, determined from analysis of historical content, consider the particular users, the frequency of a user's response, the duration between responses and interaction with other users, with respect to a topic. If the probability of the discussion thread being complete exceeds the threshold determined by historical content analysis, thread analysis program considers the discussion thread complete, and proceeds to analyze the discussion thread for user impact on decision making.

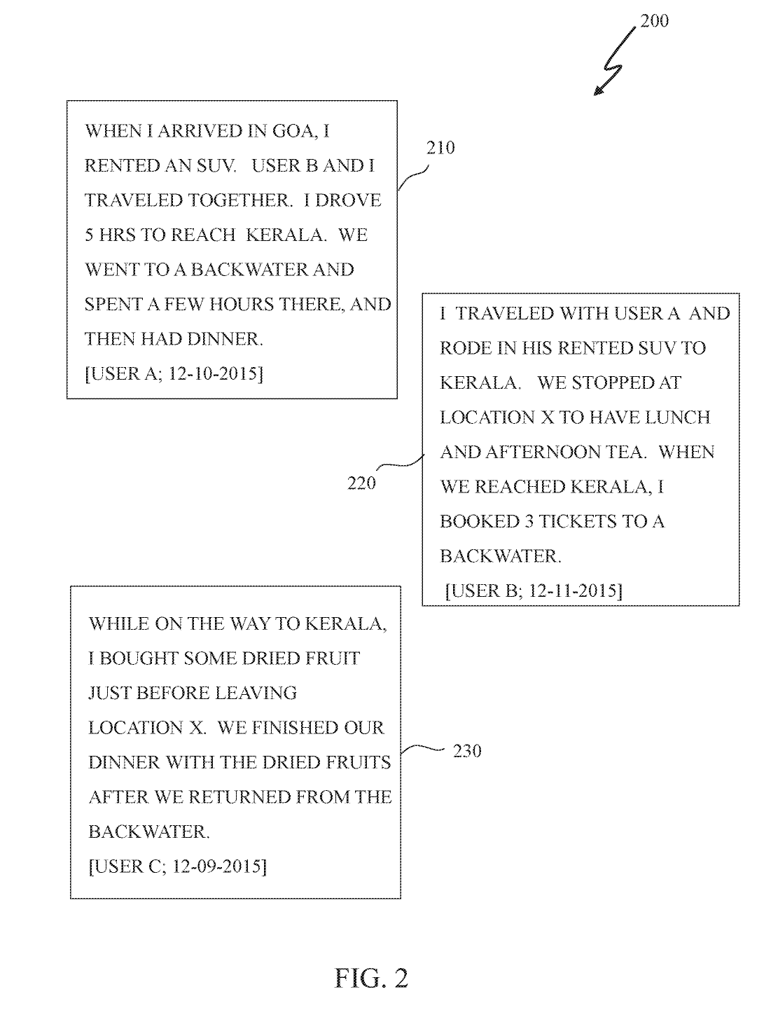

FIG. 2 illustrates an example of isolated media content generated by multiple users, in accordance with an embodiment of the present invention. FIG. 2 includes isolated contents 210, 220, and 230, which have been generated by users A, B, and C, respectively. Each content entry was made by a different user without visibility or access to the other isolated content entries, and as shown, each entry was made on a different date. Isolated content 210, 220, and 230 are accessible to thread analysis program 500 and are included in the analysis of content to determine contextual relationship of content segments. Isolated content 210, entered in a personal log of user A, for example, includes mention of travel to Goa, rental of an SUV, traveling with user B, driving to Kerala, spending a few hours at a Backwater, and having dinner. Isolated content 210 includes the use of the plural “we,” and was entered on Dec. 10, 2015. Isolated content 220, includes an entry by user B in a personal online diary, for example, and includes mention of traveling with user A, riding in the rented SUV, traveling to Kerala, stopping at location X to have lunch and tea, booking 3 tickets to a Backwater at Kerala. Isolated content 220 also uses the plural “we,” and was entered on Dec. 11, 2015. Isolated content 230 includes an entry by user C in a personal trip log maintained by user C, for example. Isolated content 230 includes mention of traveling to Kerala, buying dried fruit before leaving location X, finishing dinner after returning from the Backwater, and finishing dinner with the dried fruit. Isolated content 230 also refers to the plural “we,” and was entered on Dec. 9, 2015. Isolated content is separate from discussion thread main sources, such as popular social media sites, and public forums, blogs and wikis, and may not align with a sequential timeline of discussion thread exchanges found in other content sources. Isolated content is analyzed to determine the contextual relationship with mainstream source content as well as other isolated content from other users and may rely on relationships and behavioral patterns determined from historical content.

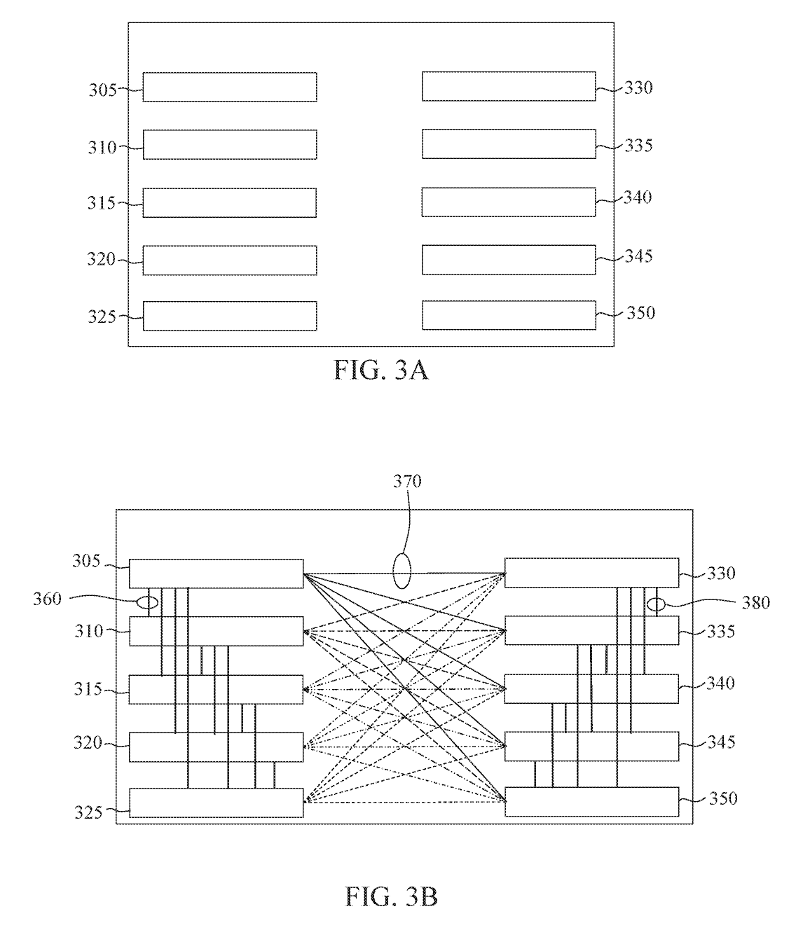

FIG. 3A is a block diagram illustrating content segments of isolated and social network content, in accordance with an embodiment of the present invention. FIG. 3A includes content segments 305, 310, 315, 320, 325, 330, 335, 340, 345, and 350. The content segments may be social network content, such as from public domain content sources 130, or may be isolated content, such as content from isolated content sources 140. In some embodiments of the present invention, content is received or gathered and stored in data repository 160, and is accessed by thread analysis program 500. Content segments 305, 310, 320, 325, 330, 335, 340, 345, and 350 may include content of different types, such as text, audio, images and video. In some embodiments of the present invention, audio content may be converted to text by an audio-to-text conversion tool working in conjunction with thread analysis program 500. Use of optical character recognition tools and image analysis tools may be used in conjunction with thread analysis program 500 to obtain text-based description of image and video frame content. Facial recognition tools may be applied to image thumbnails associated with online usernames to identify users associated with content segments from multiple platforms.

FIG. 3B is a block diagram illustrating the contextual relationship analysis of the content segments of isolated and social network content of FIG. 3A, in accordance with and embodiment of the present invention. FIG. 3B includes content segments 305, 310, 315, 320, 325, 330, 335, 340, 345, and 350. The content segments may be social network content, such as from public domain content sources 130, or may be isolated content, such as content from isolated content sources 140. The lines shown connecting each content segment with other content segments illustrates the contextual relationship analysis performed by thread analysis program 500. Thread analysis program 500 parses the content segments, which are portions of the content, and may be sentences, phrases, n-grams, or words of the content. Thread analysis program 500 identifies keywords of the parsed content segments by semantic analysis and may include sentiment analysis. Thread analysis program 500 performs comparisons of each content segment with the other content segments to determine relationships and relevancy. For example, the lines shown in FIG. 3B interconnecting each of content segments 305, 310, 315, 320, 325, 330, 335, 340, 345, and 350, represent the analytical comparison of the parsed components of each content segment to each of the other content segments. For example, connecting line 370, depicts a comparison of analyzed content segments 305 and 330, and connecting lines 360 and 380 depict the comparison of analyzed content segments between 305 and 310, and 330 and 335, respectively. Thread analysis program 500 compares keywords, key phrases, n-grams, semantics, authoring user, input timing, and input frequency, of analyzed content segments, which are considered to determine the relationship of a content segment with other content segments.

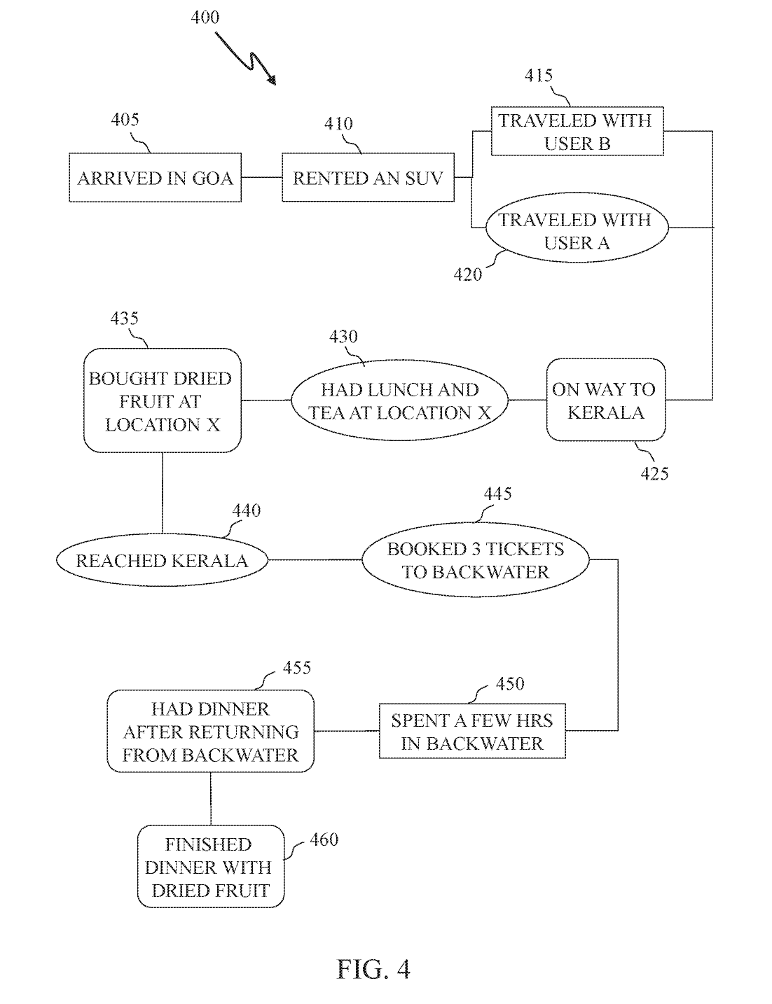

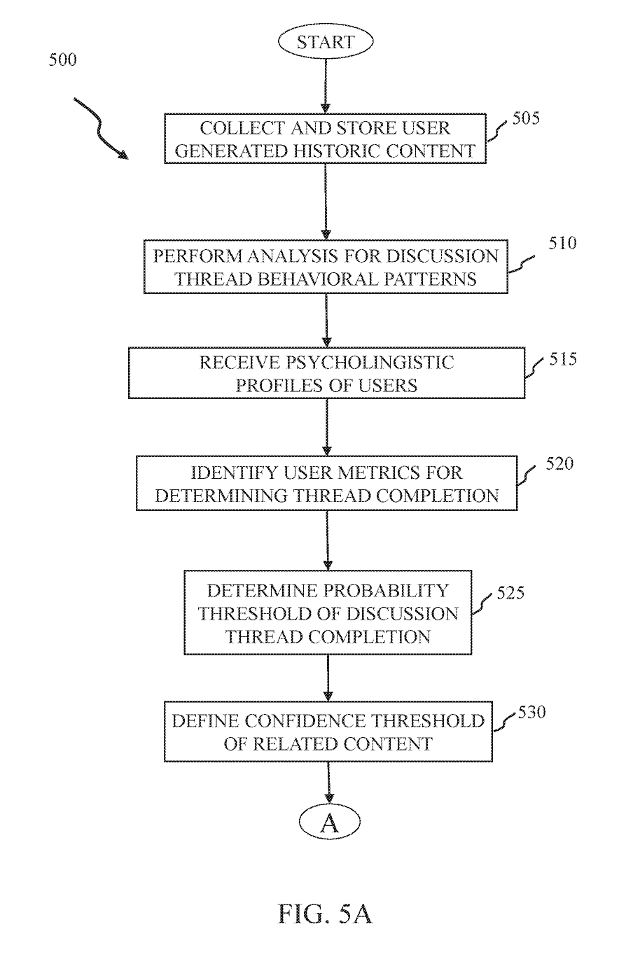

FIG. 4 depicts graphical sequence diagram 400, which includes examples of parsed content segments from the isolated content of FIG. 2, arranged in a content-determined sequence, in accordance with an embodiment of the present invention. Within a particular social media instance, the contextual relationship of content and the plurality of users generating the content can be understood and can be reasonably well defined. For the cases in which users may generate isolated content within distinct social media instances, and personal files, diaries or calendars, the contextual relationship of the isolated content with popular social media content or isolated content of other users, is more difficult to determine. Each of the parsed content segments are analyzed to determine the relationship to the other parsed content segments. In some embodiments of the present invention, content segments are grouped in clusters, based on determining a probability of content segments having a relationship in the context of a topic that is determined from identifying common and related subject matter during comparison of parsed and analyzed content segments. A discussion sequence diagram for the isolated content is generated based on determining a probability of a sequence of order of the isolated parsed content segments. In some embodiments of the present invention, a discussion sequence diagram includes content segments from isolated content and current discussion threads from one or more public source platforms.

Isolated content from users A, B, and C of FIG. 2 are assembled into a graphical display of content that is based on a determined contextual relationship between the users and the topic of the content documented in isolated instances, and based on a determined sequence of topic activity described by the content.

Content segments 405, 410, and 415 are segments from content posting by user A in isolated content 210 (FIG. 2), describing an initial part of a trip to Goa. Content segment 420 makes a connection between user B and user A regarding the trip and traveling together, as does content segment 425, which both user A and user B include in their respective isolated content 210 and 220 of FIG. 2. In some embodiments of the present invention, thread analysis program 500 applies behavior patterns of historical content that may indicate that users A, B, and C have generated content interacting with each other, and have indicated traveling together on previous occasions. The analysis of historical content enables a probability determination that the isolated content of users A, B, and C may have a contextual relationship, as well as a probability of the discussion thread between users A, B, and C may be complete or at least substantially complete.

Content segment 430 includes reference to a stop made at location X during travel, at which the travelers had lunch and also had afternoon tea. Content segment 430 is extracted from isolated content 220 of user B. Content segment 435 includes content extracted from isolated content 230 of user C, and relates user C to users A and B in traveling to Kerala, and partaking in lunch and afternoon tea by including mention of location X. Content segment 435 includes the purchase of dried fruit at location X which establishes another contextual relationship with having dinner with users A and B, through content segment 460.

Content segment 440 indicates arrival at Kerala which is related to content segment 425 and Kerala is mentioned by users A, B, and C in their respective isolated content 210, 220, and 230, further indicating that the three users traveled together to Kerala. The Kerala backwaters are a popular tourist destination that include a chain of brackish lagoons and lakes lying parallel to the Arabian Sea coast of Kerala state in southern India. Content segment 445 indicates that a user purchased (i.e., “booked”), three tickets to a backwater after reaching Kerala, and isolated content 220, which is authored by user B, includes the information of content segment 445, and establishes a contextual relationship of users A, B, and C attending a backwater. Content segment 450 includes information indicating that users A, B, and C spent a few hours at the backwater, and upon returning from the backwater, had dinner in Kerala, as is indicated by content segment 455, which is extracted from user A's isolated content 210. In content segment 460 the extracted content of user C from isolated content 230 describes the travelers as finishing their dinner by having the dried fruit purchased by user C during their lunch stop at location X. In some embodiments of the present invention, a cognitive element of thread analysis program 500 may be applied to determine sequencing of activity and relationships of activities, which may include assimilating cultural and behavioral norms for activities. For example, having lunch before tea, in which “tea” and having tea before dinner.

Graphical sequence diagram 400 provides an example of thread analysis program 500 parses and reconstructs a discussion thread sequence from isolated content, based on the context of topics, content items such as activities and places, and a relative time sequence of events. Thread analysis program 500 also makes use of the analysis of historical content discussion threads and psycholinguistic profiles to determine interaction relationships and patterns of users, whether isolated content is substantially complete.

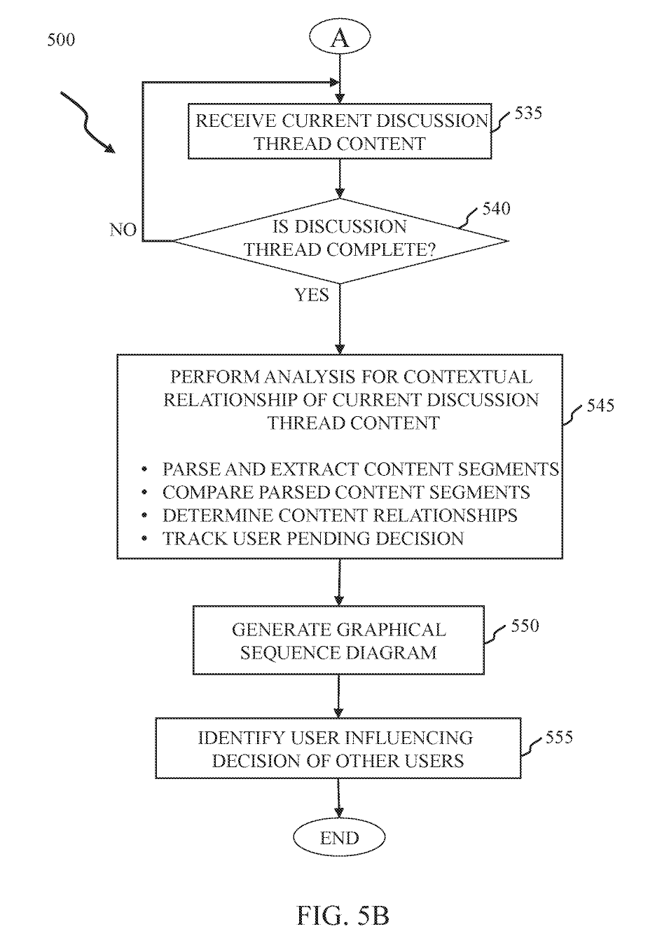

FIG. 5A illustrates operational steps of thread analysis program 500, within the distributed network processing environment of FIG. 1, in accordance with an embodiment of the present invention. In step 505, thread analysis program 500 collects and stores user generated historic content. The user generated content may be gathered over any period of time, however, information from the analysis of the historic content may be more effective if the historic content is generated over recent weeks or months, rather than years. The user generated historic content may be collected from a plurality of sources and include a plurality of users. The user generated historic content (hereafter “historic content”), may include a variety of content type, such as, but not limited to, posted text-based content, audio content, and video content. Sources may include popular social media network sites, SMS text messages that are accessible, email that is accessible, and also isolated content, such as diaries, personal logs, personal files, and calendar entries.

For example, thread analysis program 500 collects historic content from three different social media platforms for a previous six-month period of time, four designated blogs, and five selected forums, which have been made available to thread analysis program 500, and in some embodiments of the present invention the social media network content is represented by public domain content sources 130 (FIG. 1). Additionally, thread analysis program 500 is given access to historical isolated content included in personal logs, diaries, calendars, and personal files of a plurality of users that have contributed to historical content of social media networks and public source platforms. In some embodiments of the present invention, historical isolated content sources are represented by isolated content sources 140. The aggregate of collected historical content is stored in data repository 160.

In step 510, thread analysis program 500 performs analysis for discussion thread behavioral patterns. Analysis of the historical content identifies users and their corresponding activity of contribution to the generation of content and participating in various discussion threads. The analysis of behavioral patterns includes determining content types and source platform preferences for content generating users. For each user, thread analysis program 500 determines frequency of content generation, content topics, user interactions, response and thread addition frequency and timing, with respect to topic, user interaction and platform.

For example, thread analysis program 500 analyzes aggregated historical content from data repository 160, and determines the set of users generating the historical content. For each of the users, thread analysis program 500 determines the preferences of content source platforms, the frequency of content generation, the topic preferences of the user, the interaction with other users, and the discussion thread behavior of response and addition to a thread, with respect to the users contributing to the thread, the topic of the thread, and the timing or duration of responses and additions to the discussion threads.

In step 515, a psycholinguistic profile for the users that authored the historic content is generated and received by thread analysis program 500. In some embodiments of the present invention, psycholinguistic analysis tool 120 performs analysis on the historical content of data repository 160 associated with each user identified in the historical content. Psycholinguistic analysis tool 120 determines personality attributes by the word and phrase choices used in social media postings, responses, and comments to public social media content of a user. Personality attributes and traits contribute to behavioral patterns exhibited in social media interactions and contribute to determining a probability that a particular user is likely to respond or add to a discussion thread. Personality profile information for content generating uses, resulting from psycholinguistic analysis tool 120, is received by thread analysis program 500 and used in the determination of a probability that a current discussion thread is substantially complete.

In step 520, thread analysis program 500 identifies user metrics for determining thread completion. The analysis of historical content identifies the users that author the content, and includes various metrics associated with each user. Thread analysis program 500 determines the metrics associated with the historical content that contribute to establishing a probability that a discussion thread is substantially complete. Metrics determined from the historical content include, but are not limited to, the source platforms of content for each user, the frequency of generating content, the preferred topics and interactions with other users, number of responses, comments, or additions a user makes with respect to topic and other users of a discussion thread, whether a user initiates topics or more likely responds or comments, use and frequency of isolated content, and the type of content typically used to generate content. In some embodiments of the present invention, probabilities associated with determined metrics are established for each user identified in the historical content, and the metric probabilities associated with user discussion thread behavior patterns and psycholinguistic profile data are used to establish probability criteria used to determine whether a discussion thread, in which the user is participating, is substantially complete.

In step 525, thread analysis program 500 determines a probability threshold of discussion thread completion. In some embodiments of the present invention, the set of metrics identified for users generating the historical content provide for a strong correlation between observed behavioral patterns within discussion threads of a topic type, user group, and source platform, and determining whether a discussion thread is complete or nearly complete. In such cases, a probability threshold used to establish that a discussion thread is substantially complete, may be set, such as 75% probability that a discussion thread is complete (or at least substantially complete), and that analysis of the thread will not omit potentially important content. Setting the probability threshold to a high probability enables the analysis of the discussion thread content to take place only after it is determined that the threshold probability has been reached or exceeded. In embodiments in which the set of user metrics may be less complete, a higher probability threshold may be chosen to prevent analysis of the discussion thread when additional may still be added. In some embodiments of the present invention, the probability threshold of discussion thread completion may be user-chosen, and in other embodiments, the threshold may be automatically determined, based on a probability scale associated with the quantity and consistency of metrics determined for the users that have generated the historical content.

In step 530, thread analysis program 500 defines a confidence threshold of related content. As thread analysis program 500 analyzes the historical content, parsing and comparing words, phrases, and segments of the content, and comparing portions of content to other portions of content, a probability of relationship between content portions is built. A confidence threshold is set and applied to determine whether a portion of content is related to another portion of content. The confidence threshold of related content defines the level at which the contextual relationship of content segments or sentences is established. The confidence threshold of related content establishes an accepted level of certainty, such that if the probability of relationship between two or more content portions exceeds the confidence threshold, then the content portions are considered to be related as part of a discussion thread within the context of a particular topic. This is particularly applicable to isolated content or content from different data sources in which the relationship of a series of posts and responses is not clearly evident. Having defined the confidence threshold of related content, thread analysis program 500 is prepared to receive and analyze current discussion thread content and isolated content. Thread analysis program 500 proceeds to “A” and continues in FIG. 5B.

FIG. 5B illustrates operational steps of thread analysis program 500, within the distributed network processing environment of FIG. 1, in accordance with an embodiment of the present invention. In step 535, current discussion thread content is received by thread analysis program 500. The current discussion thread content may include social network content from one or more sources, and may be of one or more content types, such as text, audio, image, or video content. The current discussion thread content includes isolated content accessible to thread analysis program 500, which is associated with a particular user, but lacks time and sequence of discussion exchanges with other users. Thread analysis program 500 determines the users associated with the current discussion thread content and the isolated content, and determines discussion thread attributes, such as the topic.

In decision step 540, thread analysis program 500 determines whether the received current discussion thread is complete. In the case in which thread analysis program 500 determines that the current discussion thread is not complete (step 540, “NO” branch), thread analysis program 500 loops to step 535 and monitors the current discussion thread for receipt of additional content. For the case in which thread analysis program 500 determines that the current discussion thread is complete, (step 540, “YES” branch), thread analysis program 500 proceeds to step 545 and performs analysis for contextual relationship of content. To determine whether the current discussion thread is complete, thread analysis program 500 references the metrics and psycholinguistic profile data for the set of users participating in the current discussion thread, and determines whether the characteristics of the current discussion thread are consistent with the historic content metric probabilities associated with completion of a discussion thread for the set of users. Based on the metrics and psycholinguistic profile from the historical content analysis for each user participating in the current discussion thread, thread analysis program 500 determines an overall probability that the current discussion thread is substantially complete, and compares the probability to the previously set discussion thread completion threshold. If the determined probability that the current discussion thread meets or exceeds the completion threshold, then thread analysis program 500 considers the current discussion thread to be complete.

In step 545, thread analysis program 500 performs an analysis for contextual relationship of the content of a current discussion thread. Thread analysis program 500 parses the content of the current discussion thread into content segments that may consist of one or more words, a phrase, or a sentence. In some embodiments of the present invention, thread analysis program 500 performs a semantic analysis on the words and phrases that are parse, to assess a meaning to the content segment, and semantic and sentiment analysis is used to determine a topic(s) of the current discussion thread content. The parsed content segments are each compared to the other content segments, to determine whether a relationship exists between the content segments, and if so, determine the nature of the relationship. The parsed content segments include content from popular and public social media platforms, and the content of one platform may be isolated from content of a different platform. Parsed content segments also include content from isolated sources such as personal logs, diaries, calendars, and personal files of users, which may be generated at times that differ from content generated on social media platforms, and may not include obvious contextual relationship with other discussion content.

For example, the relationship determination may include the temporal order; whether the content segment is a comment, question, or reply; the user associated with generating the content segment; and user(s) to whom the content is directed. Thread analysis program 500 determines relationships among the parsed content segments of the current discussion threads, and concurrently tracks whether there are content segments of one or more users that indicate a pending decision or uncertainty. The pending decision or uncertainty condition of a content segment of a discussion thread is noted and associated with the user generating the content segment, or in some cases, the user(s) to which the content segment is directed to.

For example, in determining the contextual relationship of content segments of a current discussion thread, thread analysis program 500 determines that user A generates a content segment that includes a question regarding an uncertainty of a choice of action to take, and additional content segment analysis indicates that users C and D concur with the uncertainty. Thread analysis program 500 tracks and associates an uncertainty condition of content segments with users A, C, and D.

In step 550, thread analysis program 500 generates a graphical sequence diagram that represents the analyzed current discussion thread. In some embodiments of the present invention, the graphical sequence diagram includes nodes representing users that are participants of the current discussion thread, and lines, or edges connecting the nodes and representing content generated from a user corresponding to a node of the graph. The position of nodes aligns with the sequential flow of generated content, as well as replies and comments, and reflects the relationship of the topic with the participating users. The graphical sequence diagram illustrates content segments that generate continuation of content in the discussion thread as well as content segments that terminate.

In step 555, thread analysis program 500 identifies a user(s) influencing a decision or a condition of uncertainty of another user(s). In some embodiments of the present invention, thread analysis program 500 tracks the discussion thread contributions of users and determines a first user whose content contributions to the discussion thread indicate a decision to be made, or a condition of uncertainty regarding a particular subject or topic. Thread analysis program determines whether the decision or uncertainty is changed or resolved in subsequent discussion thread entries, and if there is a resolution determined within subsequent content of the discussion thread, of the pending decision or the uncertainty, thread analysis program 500 determines a second user that generated content segments previously shared with the undecided first user that contributed to the first user reaching a decisive or certain condition. Thread analysis program 500 identifies the second user as influencing a decision or uncertainty condition, with respect to the topic of the discussion thread in which the first and second users exchanged content. Identifying users that influence other users, with respect to a topic, is recorded and in some embodiments of the present invention, influential users may be applied to direct decision making. In some embodiments, a single user may influence a plurality of other users regarding a decision or opinion with respect to a particular topic. In other embodiments a plurality of users may influence a different plurality of users on a particular topic, such that there may be a one-to-one, one-to-many, many-to-many, and many-to-one, relationship of influencing users to users influenced in decisions, opinions or other conditions of uncertainty.

FIG. 6 depicts a block diagram of components of computing system 600, including server computer 605, capable of operationally performing thread analysis program 500, in accordance with an embodiment of the present invention.

Server computer 605 includes components and functional capability similar to server 110, and computing devices 170 (FIG. 1), in accordance with an illustrative embodiment of the present invention. It should be appreciated that FIG. 6 provides only an illustration of one implementation and does not imply any limitations with regard to the environments in which different embodiments may be implemented. Many modifications to the depicted environment may be made.

Computing device 605 includes communications fabric 602, which provides communications between computer processor(s) 604, memory 606, persistent storage 608, communications unit 610, and input/output (I/O) interface(s) 612. Communications fabric 602 can be implemented with any architecture designed for passing data and/or control information between processors (such as microprocessors, communications and network processors, etc.), system memory, peripheral devices, and any other hardware components within a system. For example, communications fabric 602 can be implemented with one or more buses.

Memory 606, cache memory 616, and persistent storage 608 are computer readable storage media. In this embodiment, memory 606 includes random access memory (RAM) 614. In general, memory 606 can include any suitable volatile or non-volatile computer readable storage media.

Thread analysis program 500 is stored in persistent storage 608 for execution by one or more of the respective computer processors 604 via one or more memories of memory 606. In this embodiment, persistent storage 608 includes a magnetic hard disk drive. Alternatively, or in addition to a magnetic hard disk drive, persistent storage 608 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 608 may also be removable. For example, a removable hard drive may be used for persistent storage 608. Other examples include optical and magnetic disks, thumb drives, and smart cards that are inserted into a drive for transfer onto another computer readable storage medium that is also part of persistent storage 608.

Communications unit 610, in these examples, provides for communications with other data processing systems or devices, including resources of distributed network processing environment 100. In these examples, communications unit 610 includes one or more network interface cards. Communications unit 610 may provide communications through the use of either or both physical and wireless communications links. Thread analysis program 500 may be downloaded to persistent storage 608 through communications unit 610.

I/O interface(s) 612 allows for input and output of data with other devices that may be connected to computing system 600. For example, I/O interface 612 may provide a connection to external devices 618 such as a keyboard, keypad, a touch screen, and/or some other suitable input device. External devices 618 can also include portable computer readable storage media such as, for example, thumb drives, portable optical or magnetic disks, and memory cards. Software and data used to practice embodiments of the present invention, e.g., thread analysis program 500, can be stored on such portable computer readable storage media and can be loaded onto persistent storage 608 via I/O interface(s) 612. I/O interface(s) 612 also connect to a display 620.

Display 620 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
one or more processors gathering content authored by a plurality of users over distributed network media sources, and isolated content authored by one or more users of the plurality of users, wherein the content and isolated content are directed to a plurality of topics;
one or more processors parsing the content and the isolated content;
one or more processors aggregating the content that is parsed and the isolated content that is parsed, which are directed to a topic of the plurality of topics, wherein the content that is parsed and the isolated content that is parsed, which are aggregated, form at least a portion of a discussion thread;
one or more processors identifying a set of users of the plurality of users, authoring the content that is parsed and the isolated content that is parsed, which are directed to the topic;
one or more processors determining a probability of whether the discussion thread is at least substantially complete, based on a set of metrics of behavioral patterns of the plurality of users, identified by analysis of historical content and isolated historical content authored by the plurality of users; and
in response to determining the probability of the discussion thread to exceed a probability threshold indicating the discussion thread to be at least substantially complete, one or more processors performing a contextual relationship analysis between instances of the content that is parsed and the instances of the isolated content that is parsed, which are directed to the topic, and are authored by the set of users of the plurality of users.

2. The method of claim 1, further comprising:
one or more processors gathering historical content authored by the plurality of users over distributed network sources, wherein the historical content includes historical social media content and historical isolated content, and wherein the historical content and historical isolated content includes a plurality of topics;
one or more processors parsing the historical content and historical isolated content into a plurality of historical content segments, each historical content segment of the plurality of historical content segments associated with a topic of the plurality of topics and a user of the plurality of users; and
one or more processors determining a set of behavioral metrics for each user of the plurality of users, based on activities of contribution with respect to each topic of the plurality of topics, on the historical content and historical isolated content, wherein a probability of a user adding additional content to a discussion thread is derived from the set of behavioral metrics for each user of the plurality of users.

3. The method of claim 2, further comprising:
one or more processors creating a psycholinguistic profile of each user of the plurality of users, which includes personality attributes and behavioral traits by an analysis of words and phrases used in social media interactions of the historical content authored by the plurality of users; and
one or more processors applying the psycholinguistic profile for each of the plurality of users to aggregated content segments of a discussion thread to determine, at least in part, a probability that the discussion thread is substantially complete.

4. The method of claim 1, further comprising:
one or more processors tracking content authored by each user of the discussion thread to determine whether a decision uncertainty of a first user within the discussion thread is resolved in a subsequent portion of the discussion thread; and
in response to determining a resolution of the decision uncertainty of the first user, one or more processors identifying a second user authoring content that influences the first user to resolve the decision uncertainty.

5. The method of claim 4, wherein the decision uncertainty is directed to an opinion.

6. The method of claim 1, wherein the content includes one or more content types of text, audio, images, and video, as included in social network media sites.

7. The method of claim 1, wherein the contextual relationship of the content and the isolated content of the discussion thread, which is determined to be substantially complete is represented in a graphical sequence diagram.

8. The method of claim 1, further comprising:
one or more processors defining a confidence level that a particular content segment is related to another content segment, wherein the confidence level is based on a probability threshold;
one or more processors determining a probability that a contextual relationship exists between content from different sources, based on an analysis in which the content from different sources is parsed into content segments, wherein each content segment is compared with each other content segment to determine the probability of a contextual relationship between the content segments, and wherein natural language processing, semantic analysis, and sentiment analysis techniques are applied to the content segments to determine an author, topic, and temporal sequence of the content segments; and
in response to determining the probability of a contextual relationship between two or more content segments exceeds the probability threshold of the confidence level, one or more processors determining the two or more content segments to be related.

9. A computer program product, comprising:
one or more computer readable storage devices, and program instructions stored on the one or more computer readable storage devices, the program instructions comprising:
program instructions to gather content authored by a plurality of users over distributed network media sources, and isolated content authored by one or more users of the plurality of users, wherein the content and isolated content are directed to a plurality of topics;
program instructions to parse the content and the isolated content;
program instructions to aggregate the content that is parsed and the isolated content that is parsed, which are directed to a topic of the plurality of topics, wherein the content that is parsed and the isolated content that is parsed, which are aggregated, form at least a portion of a discussion thread;
program instructions to identify a set of users of the plurality of users, authoring the content that is parsed and the isolated content that is parsed, which are directed to the topic;
program instructions to determine a probability of whether the discussion thread is at least substantially complete, based on a set of metrics of behavioral patterns of the plurality of users, identified by analysis of historical content and isolated historical content authored by the plurality of users; and
in response to determining the probability of the discussion thread to exceed a probability threshold indicating the discussion thread to be at least substantially complete, program instructions to perform a contextual relationship analysis between instances of the content that is parsed and instances of the isolated content that is parsed, which are directed to the topic, and are authored by the set of users of the plurality of users.

10. The computer program product of claim 9, further comprising:
program instructions to gather historical content authored by the plurality of users over distributed network sources, wherein the historical content includes historical social media content and historical isolated content, and wherein the historical content and historical isolated content includes a plurality of topics;
program instructions to parse the historical content and historical isolated content into a plurality of historical content segments, each historical content segment of the plurality of historical content segments associated with a topic of the plurality of topics and a user of the plurality of users; and
program instructions to determine a set of behavioral metrics for each user of the plurality of users, based on activities of contribution with respect to each topic of the plurality of topics, on the historical content and historical isolated content, wherein a probability of a user adding additional content to a discussion thread is derived from the set of behavioral metrics for each user of the plurality of users.

11. The computer program product of claim 10, further comprising:
program instructions to create a psycholinguistic profile of each user of the plurality of users, which includes personality attributes and behavioral traits by an analysis of words and phrases used in social media interactions of the historical content authored by the plurality of users; and
program instructions to apply the psycholinguistic profile for each of the plurality of users to aggregated content segments of a discussion thread to determine, at least in part, a probability that the discussion thread is substantially complete.

12. The computer program product of claim 9, further comprising:
program instructions to track content authored by each user of the discussion thread to determine whether a decision uncertainty of a first user within the discussion thread is resolved in a subsequent portion of the discussion thread; and
in response to determining a resolution of the decision uncertainty of the first user, program instructions to identify a second user authoring content that influences the first user to resolve the decision uncertainty.

13. The computer program product of claim 12, wherein the decision uncertainty is directed to an opinion.

14. The computer program product of claim 9, wherein the contextual relationship of the content and the isolated content of the discussion thread, which is determined to be substantially complete, is represented in a graphical sequence diagram.

15. The computer program product of claim 9, further comprising:
program instructions to define a confidence level that a particular content segment is related to another content segment, wherein the confidence level is based on a probability threshold;
program instructions to determine a probability that a contextual relationship exists between content from different sources, based on an analysis in which the content from different sources is parsed into content segments, wherein each content segment is compared with each other content segment to determine the probability of a contextual relationship between the content segments, and wherein natural language processing, semantic analysis, and sentiment analysis techniques are applied to the content segments to determine an author, topic, and temporal sequence of the content segments; and
in response to determining the probability of a contextual relationship between two or more content segments exceeds the probability threshold of the confidence level, program instructions to determine the two or more content segments to be related.

16. A computer system, comprising:
one or more computer processors, one or more computer readable storage devices, program instructions stored on the computer readable storage devices for execution by at least one of the one or more processors, the program instructions comprising:
program instructions to gather content authored by a plurality of users over distributed network media sources, and isolated content authored by one or more users of the plurality of users, wherein the content and isolated content are directed to a plurality of topics;
program instructions to parse the content and the isolated content;
program instructions to aggregate the content that is parsed and the isolated content that is parsed, which are directed to a topic of the plurality of topics, wherein the content that is parsed and the isolated content that is parsed, which are aggregated, form at least a portion of a discussion thread
program instructions to identify a set of users of the plurality of users, authoring the content that is parsed and the isolated content that is parsed, which are directed to the topic;
program instructions to determine a probability of whether the discussion thread is at least substantially complete, based on a set of metrics of behavioral patterns of the plurality of users, identified by analysis of historical content and isolated historical content authored by the plurality of users; and
in response to determining the probability of the discussion thread to exceed a probability threshold indicating the discussion thread to be at least substantially complete, program instructions to perform a contextual relationship analysis between instances of the content that is parsed and instances of the isolated content that is parsed, which are directed to the topic, and are authored by the set of users of the plurality of users.

17. The computer system of claim 16, further comprising:
program instructions to receive historical content authored by the plurality of users over distributed network sources, wherein the historical content includes historical social media content and historical isolated content, and wherein the historical content and historical isolated content includes a plurality of topics;
program instructions to parse the historical content and historical isolated content into a plurality of historical content segments, each historical content segment of the plurality of historical content segments associated with a topic of the plurality of topics and a user of the plurality of users; and
program instructions to determine a set of behavioral metrics for each user of the plurality of users, based on activities of contribution with respect to each topic of the plurality of topics, on the historical content and historical isolated content, wherein a probability of a user adding additional content to a discussion thread is derived from the set of behavioral metrics for each user of the plurality of users.

18. The computer system of claim 17, further comprising:
program instructions to create a psycholinguistic profile of each user of the plurality of users, which includes personality attributes and behavioral traits by an analysis of words and phrases used in social media interactions of the historical content authored by the plurality of users; and
program instructions to apply the psycholinguistic profile for each of the plurality of users to aggregated content segments of a discussion thread to determine, at least in part, a probability that the discussion thread is substantially complete.

19. The computer system of claim 16, further comprising:
tracking content authored by each user of the discussion thread to determine whether a decision uncertainty of a first user within the discussion thread is resolved in a subsequent portion of the discussion thread; and
in response to determining a resolution of the decision uncertainty of the first user, identifying a second user authoring content that influences the first user to resolve the decision uncertainty.

20. The computer system of claim 16, further comprising:
program instructions to define a confidence level that a particular content segment is related to another content segment, wherein the confidence level is based on a probability threshold;
program instructions to determine a probability that a contextual relationship exists between content from different sources, based on an analysis in which the content from different sources is parsed into content segments, wherein each content segment is compared with each other content segment to determine the probability of a contextual relationship between the content segments, and wherein natural language processing, semantic analysis, and sentiment analysis techniques are applied to the content segments to determine an author, topic, and temporal sequence of the content segments; and
in response to determining the probability of a contextual relationship between two or more content segments exceeds the probability threshold of the confidence level, program instructions to determine the two or more content segments to be related.
